(19) United States
(12) Patent Application Publication
(10) Pub. No.: US 2018/0280214 A1
(43) Pub. Date: Oct. 4, 2018

(54) SYSTEMS AND METHODS FOR MONITORING THE ACTIVITY OF WHEELCHAIR USERS

(71) Applicant: The Governors of the University of Alberta, Edmonton (CA)

(72) Inventors: Martin William Ferguson-Pell, Edmonton (CA); Kenton David Hamaluik, Edmonton (CA); Zohreh Salimi, Edmonton (CA)

(21) Appl. No.: 15/763,821

(22) PCT Filed: Oct. 5, 2016
(86) PCT No.: PCT/CA2016/051160

§ 371 Date: Mar. 27, 2018

Related U.S. Application Data
(60) Provisional application No. 62/237,669, filed on Oct. 6, 2015.

(51) Int. Cl. A61G 5/10; A61G 5/02; H04Q 9/00; G01C 9/06; G01S 19/19; G01P 1/07

(52) U.S. Cl. CPC A61G 5/10; A61G 5/02; H04Q 9/00; G01C 9/06; G01S 19/19; G01P 15/18; A61G 2203/36; A61G 2203/42; H04Q 2209/40; H04Q 2209/84; G01P 1/07

(57) ABSTRACT

A system for monitoring activity level of a wheeled vehicle while being manually propelled by a user includes a sensor, a wireless transmitter, and a base supporting the sensor and the transmitter. The base is mountable to a wheel of the wheeled vehicle. The wireless transmitter wirelessly transmits a plurality of data corresponding to sensor information received from the sensor regarding motion of the wheel over time. A remote computing device receives the data and dynamically determines a wheel-motion value according to the data. When the wheel-motion value is within a predetermined percentage of a predetermined maximum motion value, the remote computing device issues an alert to the user. If the wheel-motion value corresponds to motion of the wheel at a current time, the alert may be issued substantially in real time to alert the user that they may be over-exerting themselves.

### CROSS-REFERENCE TO RELATED APPLICATIONS

This application claims the benefit of priority of U.S. Provisional Patent Application Ser. No. 62/237,669 filed Oct. 6, 2015, which is incorporated herein by reference.

### BACKGROUND OF THE INVENTION

### (1) Field of the Invention

This disclosure relates to systems and methods for monitoring activity of wheelchair users and users of other manually propelled vehicles.

### (2) Description of the Related Art

There are about 65 million wheelchair users around the world. Many suffer from shoulder injuries due to over-use of the structures of the upper extremities during wheelchair propulsion and transfers. Over-exertion injuries result in chronic pain, reduced quality of life, increase the dependence of wheelchair users on care-givers, and lead to further loss of function. There is strong evidence that shoulder pain in wheelchair users is a serious complication with prevalence in the range of 35-75%, even for young wheelchair users. Being active and performing regular exercise is important for wheelchair users to prevent joint degeneration, to maintain cardiovascular health and to enhance upper extremity muscle strength as long as the user does not over exert and produce repetitive strain injuries, particularly to the structures of the upper extremities.

A number of products have become very popular recently to provide an indication for able-bodied persons of everyday levels of activity (e.g., products sold by Fitbit, Garmin, and Polar). Mainly designed to record walking activity and coupled in some cases with heart rate monitoring, these devices are not intended to be accurate measures of physiological energy consumption. Instead, these products provide a simple means to record and sustain daily levels of activity. Similar devices have not been produced for wheelchair users where the relationship between ambulation and cardiovascular challenge is more complex.

### BRIEF SUMMARY OF THE INVENTION

In general, this disclosure describes systems and techniques for monitoring the activity of wheelchair users. In particular, this disclosure describes techniques for determining an over exertion event. It should be noted that although the example systems described herein may be intended to help all levels of wheelchair users concerned about reducing the risk of upper extremity over-use injuries, the system offers opportunities to monitor a wide range of parameters that can assist in optimizing performance for elite sports wheelchair users, (e.g., high intensity activities such as wheelchair sprint, basketball, rugby, and endurance marathon racing).

According to an exemplary embodiment, a system is disclosed for monitoring activity. The system includes a sensor system; and a computing device in communication with the sensor system. The computing device is configured to receive data from the sensor system and determine one or more of: wheel velocity, wheelchair acceleration, wheel pushes, rolling resistance, surface incline, GPS coordinates locating the wheelchair, start time of a packet, sum of the distance traveled by pushes, average velocity of pushes, number of pushes, seconds active, and number of redline events.

According to an exemplary embodiment, the sensor system includes a first accelerometer and a second accelerometer. According to an exemplary embodiment, the first accelerometer is operably located near the center of a wheel and the second accelerometer is operably located distal to the first accelerometer.

According to an exemplary embodiment, a method of monitoring activity comprises receiving data from a sensor system and determining one or more of: wheel velocity, wheelchair acceleration, wheel pushes, rolling resistance, GPS location of user, the incline of the surface on which the wheelchair is being propelled, start time of an activity, sum of the distance traveled by pushes, average velocity of pushes, number of pushes, seconds active, and number of redline events.

According to an exemplary embodiment, an apparatus for monitoring activity comprises means for determining one or more of: wheel velocity, wheelchair acceleration, wheel pushes, rolling resistance, GPS location of user, the incline of the surface on which the wheelchair is being propelled, start time of an activity, sum of the distance traveled by pushes, average velocity of pushes, number of pushes, seconds active, and number of redline events.

According to another exemplary embodiment, a non-transitory computer-readable storage medium comprises instructions stored thereon that upon execution cause one or more processors of a device to determine one or more of: wheel velocity, wheelchair acceleration, wheel pushes, rolling resistance, start time of an activity, sum of the distance traveled by pushes, average velocity of pushes, number of pushes, seconds active, and number of redline events.

According to another exemplary embodiment, a system for monitoring activity level of a wheeled vehicle while being manually propelled by a user is disclosed. The system includes at least one sensor, a wireless transmitter coupled to the at least one sensor, and a base supporting the at least one sensor and the wireless transmitter. The base is mountable to a wheel of the wheeled vehicle. The wireless transmitter is operable to wirelessly transmit a plurality of data corresponding to sensor information received from the at least one sensor regarding the motion of the wheel over time.

According to another exemplary embodiment, disclosed is a method of monitoring activity level of a wheeled vehicle while being manually propelled by a user. The method includes supporting at least one sensor and a wireless transmitter on a base, mounting the base to a wheel of the wheeled vehicle, and wirelessly transmitting a plurality of data corresponding to sensor information received by the wireless transmitter from the at least one sensor regarding motion of the wheel over time.

According to another exemplary embodiment, a system is disclosed for monitoring activity level of a wheeled vehicle while being manually propelled by a user includes a sensor, a wireless transmitter, and a base supporting the sensor and the transmitter. The base is mountable to a wheel of the wheeled vehicle. The wireless transmitter wirelessly transmits a plurality of data corresponding to sensor information received from the sensor regarding motion of the wheel over time. A remote computing device receives the data and dynamically determines a wheel-motion value according to the data. When the wheel-motion value is within a predetermined percentage of a predetermined maximum motion value, the remote computing device issues an alert to the user. If the wheel-motion value corresponds to motion of the wheel at a current time, the alert may be issued substantially in real time to alert the user that they may be over-exerting themselves.

The details of one or more examples are set forth in the accompanying drawings and the description below. Other features, objects, and advantages will be apparent from the description and drawings, and from the claims.

These and other advantages and embodiments of the present invention will no doubt become apparent to those of ordinary skill in the art after reading the following detailed description of preferred embodiments illustrated in the various figures and drawings.

### BRIEF DESCRIPTION OF THE DRAWINGS

The invention will be described in greater detail with reference to the accompanying drawings which represent preferred embodiments thereof:

FIG. 1 is a conceptual diagram illustrating an example system that may implement one or more techniques of this disclosure.

FIG. 2 is a conceptual diagram illustrating an example of a sensor system according to one or more techniques of this disclosure.

FIG. 3 is a conceptual diagram illustrating an example of a computing device that may implement one or more techniques of this disclosure.

FIG. 4 is a conceptual diagram illustrating an example of a communication protocol that may communicate data between a sensor system and a computing device of this disclosure.

FIG. 5 is a picture illustrating examples of mounting the sensor system of FIG. 2 to a plurality of different types of wheels that may be included on a wheelchair.

FIG. 6 is a conceptual diagram illustrating an example of a wheel and a sensor system operably coupled thereto that may implement one or more techniques of this disclosure.

FIG. 7 is a graph illustrating the results of example tests on example systems implemented according to one or more techniques of this disclosure.

FIG. 8 is a graph illustrating a typical signal from the sensor system for a single wheelchair push.

FIG. 9 is a graph illustrating an example comparison of an example implementation of the system described herein to Smart^{WHEEL}.

FIG. 10 is a graph illustrating the results of the example test for an example system implemented according to one or more techniques of this disclosure and demonstrating the maximum capacity of a user and the 80% Redline level.

FIG. 11 is a graph illustrating the results of example tests on example systems implemented according to one or more techniques of this disclosure and demonstrating the application of an algorithm to detect individual pushes.

FIG. 12 shows a graph of the Calibration Test Wheel Rotated in 90 degree Increments then Lain on Side.

FIG. 13 shows a graph of output values during a calibration test with calibration constants applied.

FIG. 14 illustrates the Angular velocity for a single maximum push on a cobbled surface during calibration.

FIG. 15 illustrates the Angular Acceleration for a single maximum push on a cobbled surface during calibration.

FIG. 16 illustrates the colour coded exertion results for a single maximum push on a cobbled surface during calibration.

FIG. 17 illustrates the Angular velocity for pushing on linoleum for multiple sub-maximal pushes during calibration.

FIG. 18 illustrates the Angular Acceleration for pushing on linoleum for multiple sub-maximal pushes during calibration.

FIG. 19 illustrates the colour coded exertion results for pushing on linoleum for multiple sub-maximal pushes during calibration.

### DETAILED DESCRIPTION

The PCI (Physiological Cost Index) is a simple, easy-to-measure indicator of the physiological cost associated with walking. It is an indicator of energy cost during walking for a self-selected speed. PCI has been investigated for its potential for the remote monitoring of wheelchair users' levels of activity. In a recent study under carefully controlled conditions, Salimi Z, Ferguson-Pell M W, Ramadi A, Haennel R, Mohammadi F, Qi L. investigated validation of the physiological cost index for wheelchair users. In 15th Biomedical Engineering conference (BME) Program and Proceedings; p. 73, it was found that PCI is not a valid measure of the physiological cost of wheelchair ambulation. Further, a review of studies that have considered the use of activity monitors for measuring meaningful wheelchair activities suggests that they are not reliable. Activity monitors such as Actiwatch, CSA (Computer Science and Applications Inc.), and PAMS&GWRM (Physical Activity Monitoring and Sharing System (PAMS) and a gyroscopic-based wheel rotation monitor (GWRM) mounted on a wheel developed by the Human Engineering Research Laboratories) have been studied. The Actiwatch and CSA (Computer Science and Applications Inc.) were shown to have an intermediate correlation (˜50 to 60%) with self-reported activity level and energy expenditure, respectively. Actiwatch and CSA do not provide measures like push counts that are informative and beneficial for wheelchair users. PAMS&GWRM provides very limited information for wheelchair users and does not resolve inherent design limitations due to vibrational noise during use on typical surfaces.

The techniques described herein may be used to measure both the level of activity and also the frequency with which the wheelchair user over-uses his/her upper extremities during wheelchair propulsion in everyday activities.

Studies conducted by Ferguson-Pell and colleagues proposed the concept of “redlining.” In one example, redlining occurs when the peak propulsion force generated in performing a wheelchair task exceeds 80% of the maximum capacity of the user to push their wheelchair. A reference measurement may be made to determine the wheelchair users' maximum capacity. The propulsion forces generated when propelling may be compared to this reference value. Each time the user exceeds 80% of their maximum capacity (or another percentage in other examples) they are considered to have “redlined.” There are many examples in human physiology where extreme exertion is considered to occur at about 80% of maximum capacity. This threshold has therefore been chosen in one example to provide an indicator in the example algorithm described below. Multiple thresholds or even statistical measures such as the levels of quartiles of propulsion intensity may also be provided to wheelchair users by applying the same concept. For example, all pushes could be classified into categories such as “low exertion,” “medium exertion,” “high exertion,” and “over-exertion.” In some examples, a dashboard graphical user interface may present summary information to the user and can provide a record in each of these categories of exertion.

Clinical instrumentation has been developed that enables wheelchair propulsion forces to be measured accurately for clinical assessment purposes. The Smart^{WHEEL} has been the most widely used and studied. These devices are essentially instrumented wheelchair wheels and are temporarily fitted to the wheelchair user's wheelchair in order to undertake a clinical assessment. They are not intended or practical for use as a replacement to the user's everyday wheelchair wheels. Furthermore, the information the Smart^{WHEEL} and similar devices collect requires expert interpretation. The example systems described herein may overcome the limitations associated with Smart^{WHEEL} and other conventional systems where indicators rather than active measurement of activity and over exertion are required.

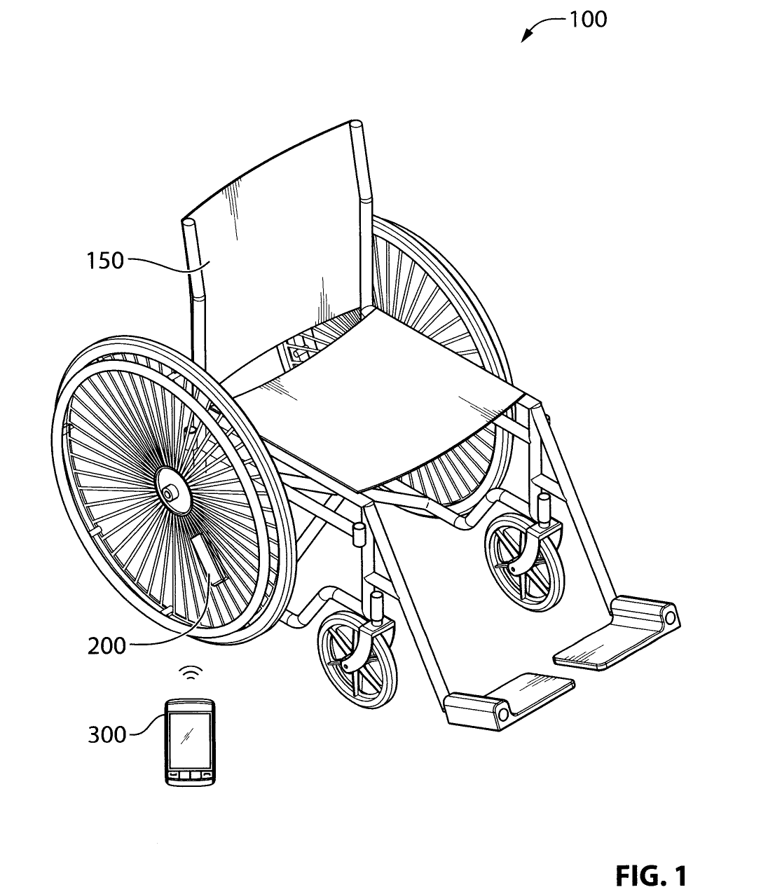

FIG. 1 is a conceptual diagram illustrating an example system that may implement one or more of the techniques of this disclosure. Referring to FIG. 1, system 100 includes a sensor system 200 mounted on a wheel of a wheelchair 150, and a remote computing device 300. It should be noted that in one example, sensor system 200 may be based on an Application Note by Kionix Inc. comprising two 3-axis accelerometers mounted on a thin profile rigid substrate that also serves to make electrical connections between the sensor components. The sensor system 200 may be supported on any suitable base material such as a substrate made of plastic, which is mountable to the wheel of the wheelchair 150.

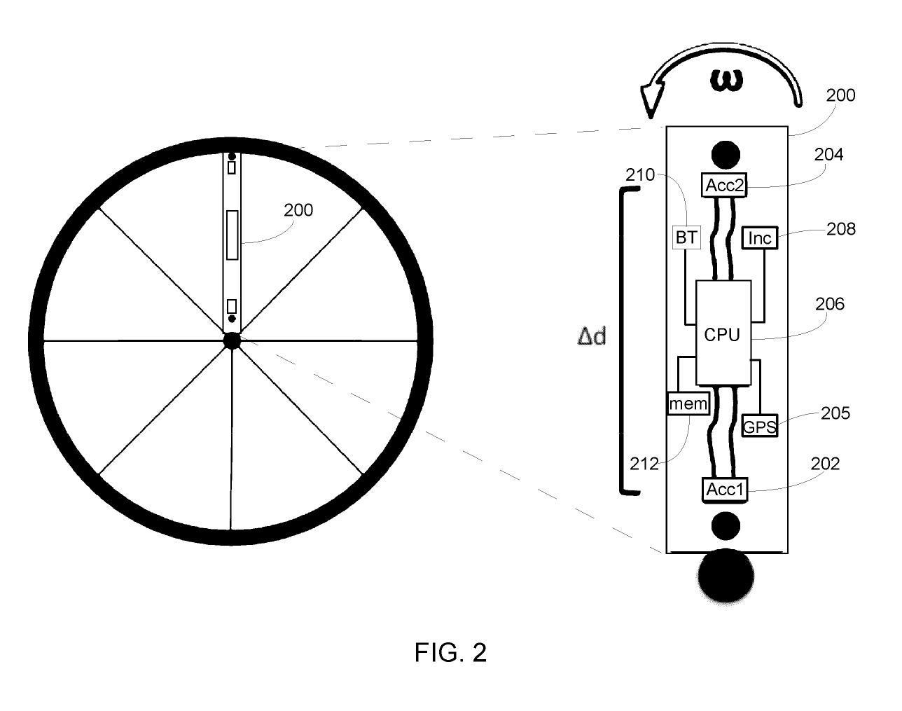

FIG. 2 is a conceptual diagram illustrating an example of a sensor system according to one or more techniques of this disclosure. As illustrated in FIG. 2, sensor system 200 is mounted to spokes of the wheelchair wheel and includes a first accelerometer 202, a second accelerometer 204, global positioning system (GPS) receiver 205, computing device 206, an inclinometer 208, a Bluetooth wireless transceiver 210, and a flash memory device 212. In the example illustrated in FIG. 2, the first and second accelerometer 202 and accelerometer 204 may include 3-axis accelerometers. In other examples accelerometer 202 and accelerometer 204 may include 2-axis accelerometers. Other or additional sensor(s) may also be included in other embodiments. For instance, an integrated altimeter may be included within sensor system 200 to enable calculating the slope of a surface, rather than or in addition to the inclinometer 208.

As described by Kionix, the distance (Δd) between the accelerometers 202 and 204 should be maximized in some cases to obtain optimal sensitivity. When the wheel rotates with angular velocity ω, the centripetal (radial direction) acceleration experienced by the two accelerometers 202 and 204 is different due to the difference in their distance from the center of rotation (the hub of the wheel). For instance, when mounted on the wheel in the position shown in FIG. 2, the first accelerometer 202 is located closer to the inner hub of the wheel, and the second accelerator 204 is located closer to the outer rim of the wheel. Once the instantaneous angular velocity of the wheel has been determined, it is possible to calculate the change in the acceleration of the wheel, and therefore the acceleration of wheelchair that can be attributed to the propulsion force applied by the user, based on Newton's 2^{nd} Law of Motion (Force=mass×acceleration). The force estimated from the acceleration of the wheelchair does account for the opposing force of the rolling resistance or any incline of the surface, and so adjustments for these factors are made both in the instrumentation and the algorithm used to estimate the propulsion force in this configuration.

It should be noted that, in principle, only one accelerometer is needed to estimate the angular velocity of the wheelchair. However, spurious vibrations and impacts detected by a single accelerometer may swamp the propulsion acceleration signal even when filtering techniques are used to detect acceleration signals likely to be in the range of the propulsion forces. By using two accelerometers, since both experience the same spurious acceleration signals, then the difference between them can be attributed to the difference in centripetal acceleration associated with Δd and co. However, in other embodiments a single accelerometer 202, 204 is utilized to estimate the angular velocity.

It should be noted that in some examples, accelerometers 202 and 204 may be calibrated. An example of a calibration process according to some embodiments is described in Appendix A.

In the example illustrated in FIG. 2, the sensor system 200 includes a GPS receiver 205 and an inclinometer 208. GPS receiver 205 may be configured to receive signals (e.g., three or more satellite time signals) in order to correlate the position of the wheelchair. Inclinometer 208 may be configured to measure the angle of the wheelchair. It should be noted that in other examples additional or fewer sensors may be included as part of sensor system 200.

In the example illustrated in FIG. 2, the first and second accelerometers 202 and 204 are in communication with a computing device 206. In one example, the computing device 206 in-eludes a microcontroller and one or more communications transceiver(s). The microcontroller may include one or more processors operable to execute software instructions loaded from an attached memory device such as the flash storage device 212. In the following description the singular form of the word “processor” will be utilized as it is common for an embedded CPU of a portable computing device to have a single processor (sometimes also referred to as a core); however, it is to be understood that multiple processors may also be configured to perform the described functionality of the computing device 206 in other implementations. For example, the microcontroller computing device 206 of the sensor system 200 may be implemented with a multi-core architecture. In one example, the computing device 206 applies the algorithms and sensor data collection outlined below at a sampling rate of at least 10 Hz. A real time clock included within the computing device 206 (or coupled to computing device 206) may record the timing of the data records and a low energy Bluetooth RF transmitter-receiver 210 may communicate between sensor system 200 and a remote computing device 300. Of course, other types of communications interfaces may be employed as desired such as WiFi communications implemented by a WiFi transceiver chip (not shown), or even communications ports for wired connections such as universal serial bus (USB).

In one example, the remote computing device 300 may include a mobile device such as a cell phone. In one example, a wrist-worn Bluetooth-enabled sensor or other portable/wearable electronic device may be used optionally such that each time the propulsion force is determined to be above the “red line” a micro-vibration motor pulses to provide real-time feedback to the wheelchair user. For instance, the user may feel the wrist or other wearable device buzz upon high exertion detected. The feedback may be intended to encourage the wheelchair user to moderate their propulsion forces and reduce the risk of over-use injury. Various types of alerts may be utilized in different embodiments to provide feedback such as vibrations, audible tones and announcements, visual signals such as warning lights, etc.

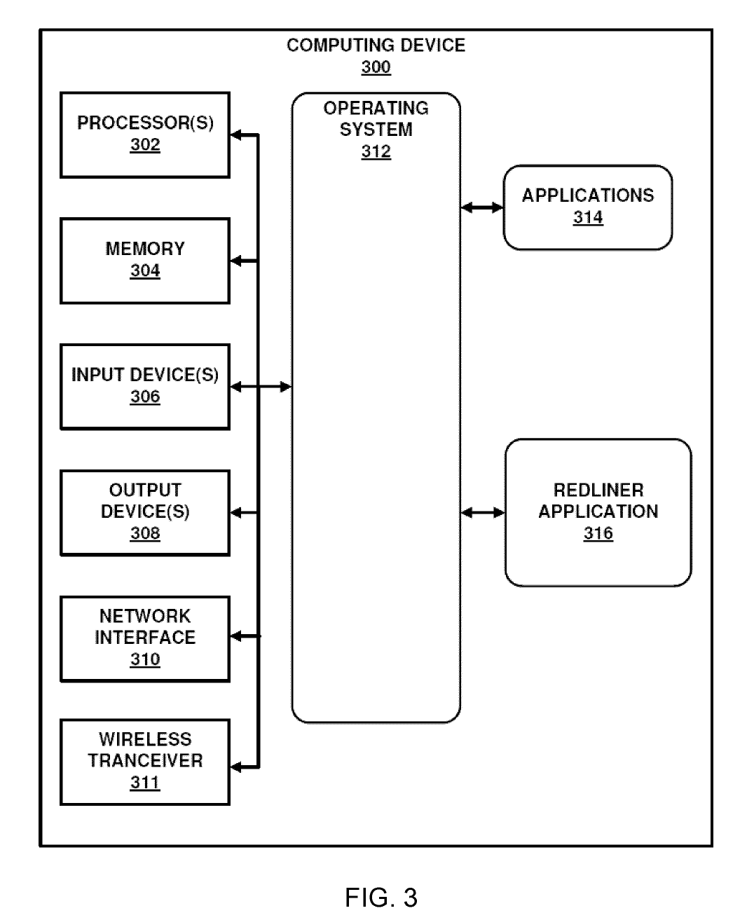

FIG. 3 is a conceptual diagram illustrating an example of a remote computing device 300 that may implement one or more techniques of this disclosure. Computing device 300 is an example of a computing device that may be configured to transmit data to and receive data from the sensor system 200 and execute one or more applications (e.g., redliner application 316) loaded from a memory 304, for example. Computing device 300 may include or be part of a portable computing device (e.g., a mobile phone, netbook, laptop, personal data assistant (PDA), or tablet device) or a stationary computer (e.g., a desktop computer, or set-top box), or may be another computing device. Computing device 300 includes processor(s) 302, memory 304, input device(s) 306, output device(s) 308, network interface 310, and wireless transceiver 311. Each of processor(s) 302, memory 304, input device(s) 306, output device(s) 308, network interface 310, and wireless transceiver 311 may be interconnected (physically, communicatively, and/or operatively) for inter-component communications. Operating system 312, applications 314, and redliner application 316 may be executable by computing device 300. It should be noted that although example computing device 300 is illustrated as having distinct functional blocks, such an illustration is for descriptive purposes and does not limit computing device 300 to a particular hardware architecture. Functions of computing device 300 may be realized using any combination of hardware, firmware, and/or software implementations.

Processor(s) 302 may be configured to implement functionality and/or process instructions for execution in computing device 300. Processor(s) 302 may be capable of retrieving and processing instructions, code, and/or data structures for implementing one or more of the techniques described herein. Instructions may be stored on a computer-readable medium, such as memory 304. Processor(s) 302 may be digital signal processors (DSPs), general purpose microprocessors, application specific integrated circuits (ASICs), field programmable logic arrays (FPGAs), or other equivalent integrated or discrete logic circuitry.

Memory 304 may be configured to store information that may be used by computing device 300 during operation. Memory 304 may be described as a non-transitory or tangible computer-readable storage medium. In some examples, memory 304 may provide temporary memory and/or long-term storage. In some examples, memory 304 or portion thereof may be described as volatile memory, i.e., in some cases, memory 304 may not maintain stored contents when computing device 300 is powered down. Examples of volatile memories include random access memories (RAM), dynamic random access memories (DRAM), and static random access memories (SRAM). Memory 304 may be internal or external memory and in some examples may include non-volatile storage elements. Examples of such non-volatile storage elements may in-dude magnetic hard discs, optical discs, floppy discs, flash memories, or forms of electrically programmable memories (EPROM) or electrically erasable and programmable (EEPROM) memories.

Input device(s) 306 may be configured to receive input from a user operating computing device 300. Input from a user may be generated as part of a user running one or more software applications, such as redliner application 316. Input device(s) 306 may include a touch-sensitive screen, track pad, track point, mouse, a keyboard, a microphone, video camera, or any other type of device configured to receive input from a user.

Output device(s) 308 may be configured to provide output to a user operating computing device 300. Output may include tactile, audio, or visual output generated as part of a user running one or more software applications, such as redliner application 316. Output device(s) 308 may include a touch-sensitive screen, sound card, a video graphics adapter card, or any other type of device for converting a signal into an appropriate form understandable to humans or machines. Additional examples of an output device(s) 308 may include a speaker, a cathode ray tube (CRT) monitor, a liquid crystal display (LCD), or any other type of device that can provide output to a user. In the example where computing device 300 is a mobile device, output device(s) 308 may be an LCD or organic light emitting diode (OLED) display configured to receive user touch in-puts, such as, for example, taps, drags, and pinches.

Network interface 310 may be configured to enable computing device 300 to communicate with external devices via one or more networks. Network interface 310 may be a network interface card, such as an Ethernet card, an optical transceiver, a radio frequency transceiver, or any other type of device that can send and receive information. Network interface 310 may be configured to operate according to one or more of the communication protocols. Wireless transceiver 311 may be a wireless transceiver configured to send and receive data. In one example, wireless transceiver 311 and network interface 310 may be integrated.

Operating system 312 may be configured to facilitate the interaction of applications, such as application 314 and redliner application 316, with processor(s) 302, memory 304, input device(s) 306, output device(s) 308, network interface 310, and wireless transceiver 311 of computing device 300. Operating system 312 may be an operating system designed to be installed on laptops and desktops. For example, operating system 312 may be a Windows operating system, Linux, or Mac OS. In another example, if computing device 300 is a mobile device, such as a smartphone or a tablet, operating system 312 may be one of Android, iOS or a Windows mobile operating system.

Applications 314 may be any applications implemented within or executed by computing device 300 and may be implemented or contained within, operable by, executed by, and/or be operatively/communicatively coupled to components of computing device 300. Applications 314 may in-dude instructions that may cause processor(s) 302 of computing device 300 to perform particular functions. Applications 314 may include algorithms which are expressed in computer programming statements, such as, for-loops, while-loops, if-statements, do-loops, etc. Applications may be developed using a programming language. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, Python, UNIX Shell, Visual Basic or Visual Basic Script, Virtual Reality Markup Language (VRML), ColdFusion™ and other compilers, assemblers, and interpreters.

Redliner application 316 is an example of an application configured to monitor a wheelchair user's activities according to the techniques described herein. In one example, redliner application 316 can be downloaded by the user and periodically communicate with the sensor system 200 using either a standard communications protocol or a proprietary Bluetooth protocol developed for the redliner application 316, e.g., application 318. Redliner application 316 may provide feedback to the user on recent propulsion events, providing a range of parameters that are indicators of the level of activity and over-exertion. Furthermore, computing device 300 may act as a bridge to a password protected web-based dashboard where a more comprehensive record of propulsion activity and a long-term archive is maintained for each user. Data from the redliner application 316 may be sent via the Internet or another network to a computer server for storage and further processing. Data associated with the archive guidance can be given to indicate if the user's typical propulsion behavior is considered to be in a low medium or high risk for injury category based on data-mining of accumulated records of a large number of users. Specific advice on how to reduce overuse risk may also be provided based on normative data records, such as to advise a user to perform longer stroke-lengths, a less impulsive propulsion technique, or less intensive standing-start pushes.

The sensor system 200 transmits a plurality of data corresponding to sensor information received from the accelerometers 202, 204 and/or other sensor 205, 208 regarding motion of the wheel of the wheelchair 150 over time. In some embodiments, the data transmitted is in real time so that alerts can be issued to the user as exertion by the user reaches predetermined thresholds. The user's exertion is calculated by the redliner application 316 by first determining one or more wheel-motion values. Examples of different wheel-motion values include wheel velocity, wheel acceleration, and wheel pushes, and algorithms that may be utilized to calculate each by the one or more processors executing the redliner application 316 are provided in the following.

In one example, redliner application 316 may be configured to calculate wheel velocity. In one example, angular wheel velocity may be calculated according to Equation 1.

Equation 1

$$ω = \sqrt{\frac{{a}_{x 2} - {a}_{x 1}}{Δ d}}$$

Where aₓ are the measured accelerations along the radial axis, and Δd is the distance between the accelerometers 202 and 204.

In one example, redliner application 316 may be configured to calculate wheelchair acceleration. In one example, wheelchair acceleration may be calculated according to Equation 2.

Equation 2

$${a}_{wc} = {r}_{w} \frac{\partial \overline{{ω}_{w}}}{\partial t}$$

Where r_{w} is the radius of the wheelchair wheel, and ω̅_̅{̅w̅}̅ is the moving mean of ω_{w}.

In one example, redliner application 316 may be configured to detect wheel pushes. In one example, push detection involves analyzing a scrolling window of past wheelchair accelerations and capturing if (and when) the acceleration signal adheres to three criteria:
1. The signal becomes strictly positive. (a_{wc}>0)
2. The signal becomes sufficiently massive. (a_{wc}>aₜₕ)
3. The above two conditions are achieved for a sufficiently lengthy period of time. (tₚ≥tₘᵢₙ)

Once the three criteria are met, a push is detected with its endpoint being the period in time where any one of the criteria fails.

In one example, redliner application 316 may be configured to estimate rolling resistance. In one example, once a push has been completed, system 100 begins measuring negative acceleration (deceleration) due to the rolling resistance of the surface. Over the periods between active pushes, going back over an adequately sized time window, the mean deceleration may be calculated and used as an indicator of rolling resistance, (a_{R}).

In one example, redliner application 316 may be configured to calculate output parameters. Example output parameters include:
1. Start time of the packet.
2. The sum of the distance traveled by the pushes, calculated as by, e.g.:

$${\sum }_{n = 1}^{N} {r}_{w} {\int }_{0}^{{t}_{p , n}} {ω}_{w , n} dt$$

Where tₚ is the length of the push in seconds.
3. The average velocity of the pushes, calculated as by, e.g.:

$$\frac{{\sum }_{n = 1}^{N} {r}_{w} \frac{{\int }_{0}^{{t}_{p , n}} {ω}_{w , n} dt}{{t}_{p , n}}}{N}$$

4. The number of pushes, N
5. The seconds active, calculated as by, e.g.:

$${\sum }_{n = 1}^{N} {\int }_{0}^{{t}_{p , n}} H ( {a}_{wc , n} - {a}_{th , n} ) dt$$

Where H(x) is the Heaviside step function, and aₜₕ is an adequately sized threshold acceleration.
6. The number of Redline events, calculated as by, e.g.:

$${\sum }_{n = 1}^{N} H [ max ( {a}_{wc , n} ) + {a}_{R} - RR \cdot ( a\_max + {a}_{R , calib} ) ]$$

Where RR is the redline ratio, aₘₐₓ is the per-user calibrated maximum push intensity, and a_{R,calib} is rolling resistance found when calibrating aₘₐₓ.

In one example, one or more of the above output parameters are continually calculated and recorded over a configurable recording period and become data accessible to the user. It should be noted that more complex algorithms have been developed and may be used to account for non-straight-line pushing. More complex algorithms may use two sensor systems 200, one to each wheel, and communication between them before uploading data to the computing device 300.

As illustrated above, in some embodiments, the rotational acceleration is estimated by differentiating the rotational velocity. However, in some situations, this has been found to be noisy. As an alternative technique, better results may be obtained by calculating the rotational acceleration by measuring the tangential acceleration. To estimate rotational acceleration according to tangential acceleration, the first and second accelerometers 202, 204 are implemented as two biaxial accelerometers, each measuring the axial and tangential acceleration components.

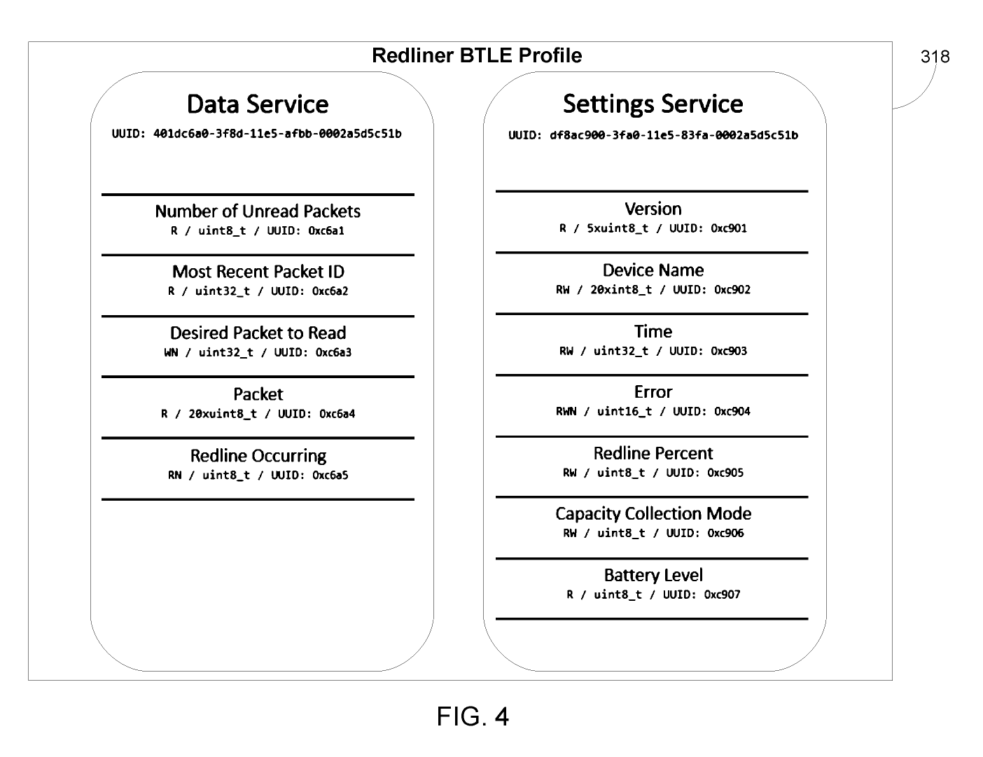

As described above, in one example, redliner application 316 may periodically communicate with the sensor system 200 using a proprietary Bluetooth protocol developed for redliner application 316. FIG. 4 is a conceptual diagram illustrating an example of an application that may implement one or more techniques of this disclosure. As illustrated in FIG. 4, application 318 includes data service component including a number of unread packets, most recent packet ID, desired packet to read, packet, and redline occurring components and setting service component including version, device name, time, error, redline percent, capacity collection mode, and battery level components.

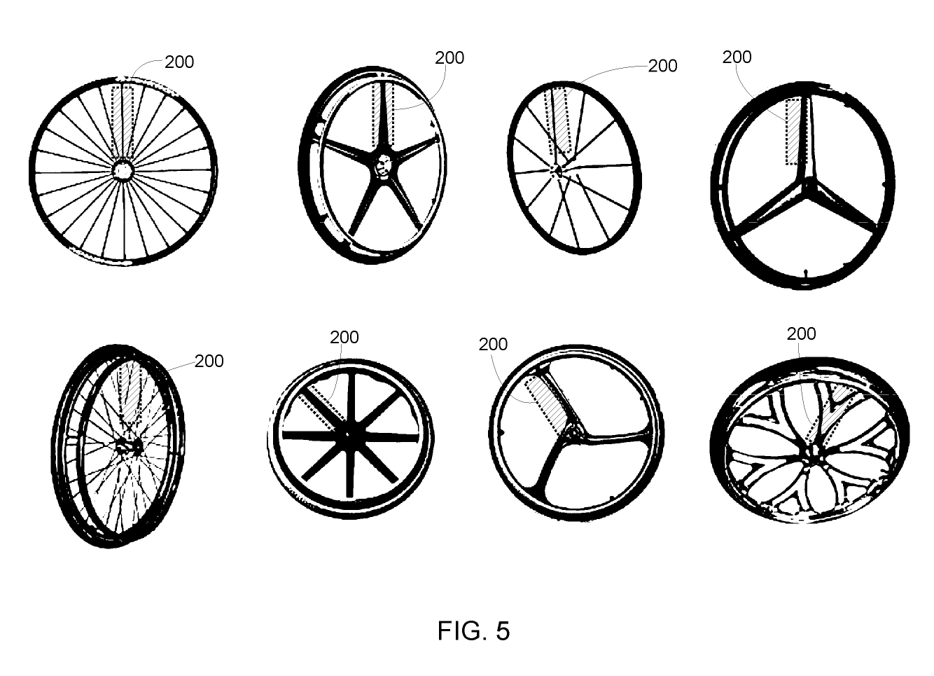

Wheelchairs may include several different types of wheels. FIG. 5 is a picture illustrating examples of types of wheels that may be included on a wheelchair and how the sensor system 200 may be mounted on each according to exemplary embodiments. A range of attachment options may be provided with sensor system 200, to accommodate the differences in wheelchair wheel design and dimensions. One example for attaching sensor system 200 to a wire spoke wheelchair wheel, (which is the style most widely used) is illustrated in FIG. 6. As illustrated in FIG. 6, one or more backing plates with guides 600 may be used to operably mount sensor system 200 to a wheelchair wheel. Examples of means for mounting the sensor system 200 to a wheel include clamps, guides rails, clips, ties, magnetic locks, friction fit, elastic loops, and cords. In some embodiments, the sensor system 200 is mounted to a wheel by the end user and the wheel is just a normal wheelchair wheel and does not need to have special manufacturing requirements. In some embodiments, the sensor system 200 is mounted to a corresponding wheel that has corresponding mounting hardware and/or a position suited for mounting on the wheel prepared in advance during the manufacturing process of the wheel.

Packaging may also be included on the sensor system 200 and/or wheel in order to protect the circuitry and sensor(s) 202, 204, 205, 206, 208 of the sensor system 200. For example, the sensor system 200 may be housed within a waterproof plastic package or may be mounted within a water-proof housing available on the wheel. In some embodiments, the sensor system 200 is both mountable to the wheel and removable from the wheel by the end user thereby allowing the user to use a single sensor system 200 at different times on different vehicles.

A series of tests have been performed on example system 100 in real world settings: on grass, linoleum, cobblestones, and asphalt. On each of these surfaces, a set of four tests was completed: straight-line pushing, maneuvering, maximal push, and coast down. The maximum acceleration obtained from the maximal test in each setting (e.g. asphalt) was used to estimate the maximum force the participant could apply in that setting. Then, all the instances that the participant exceeded 80% of this maximal force is considered to be “red-lining”, or over-exertion.

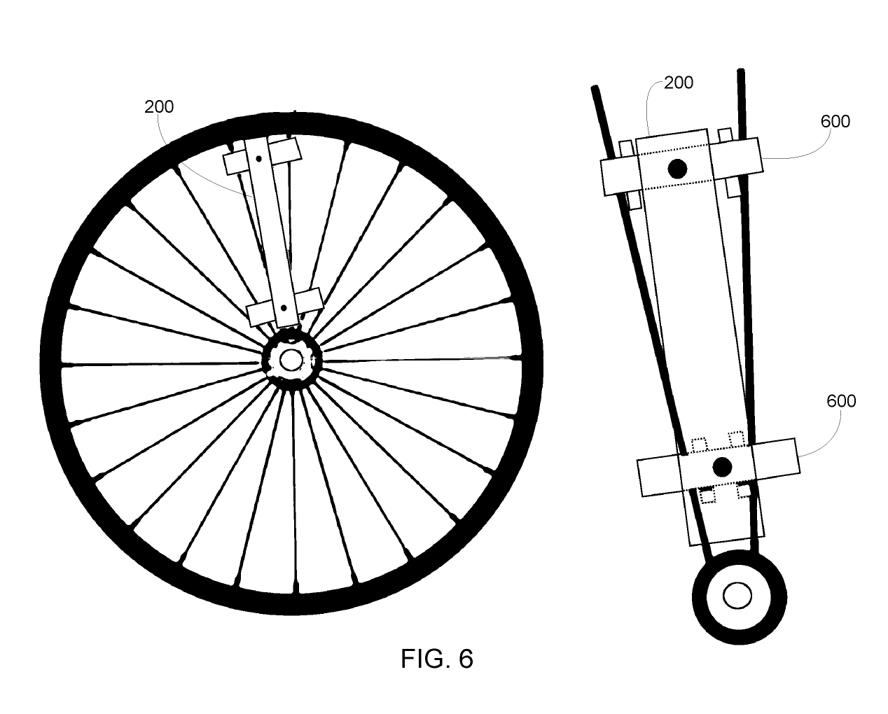

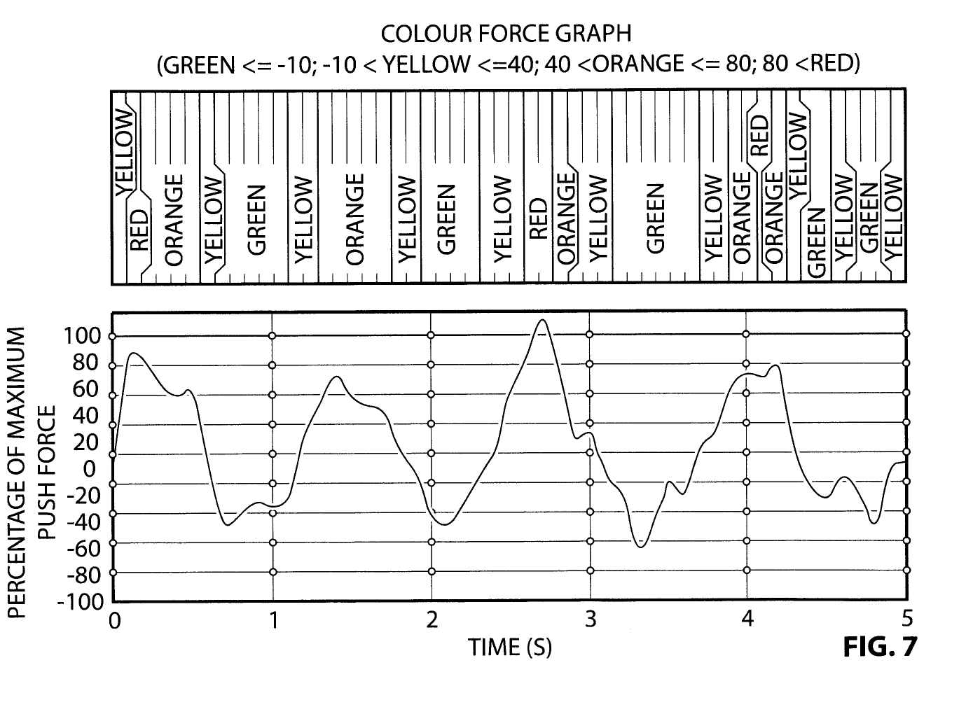

FIG. 7 is a graph illustrating the results on example test on the example system implement according to one or more techniques of this disclosure. In FIG. 7, the results for the task of propelling wheelchair in a straight line on grass is shown. A grass surface represents a particularly challenging task both for the wheelchair user and for sensors 202 and 204. The result for one participant is shown in FIG. 7.

FIG. 7 may be displayed to the user on a display device of the remote computing device 300 for example. When displayed, the colour force graph shown in the upper portion of FIG. 7 would preferably utilize colours rather than or in addition to words indicating the colour. Although only four colours: green, yellow, orange, red are utilized in this example, in other implementations additional colours may be utilized. For instance, additional shades of green turning into yellow, additional shades of yellow turning into orange, additional shades of orange turning into red, and additional shades of red may all be utilized depending on the measured percentage of maximum push force. In this way, the colour displayed to the user visually represents the force.

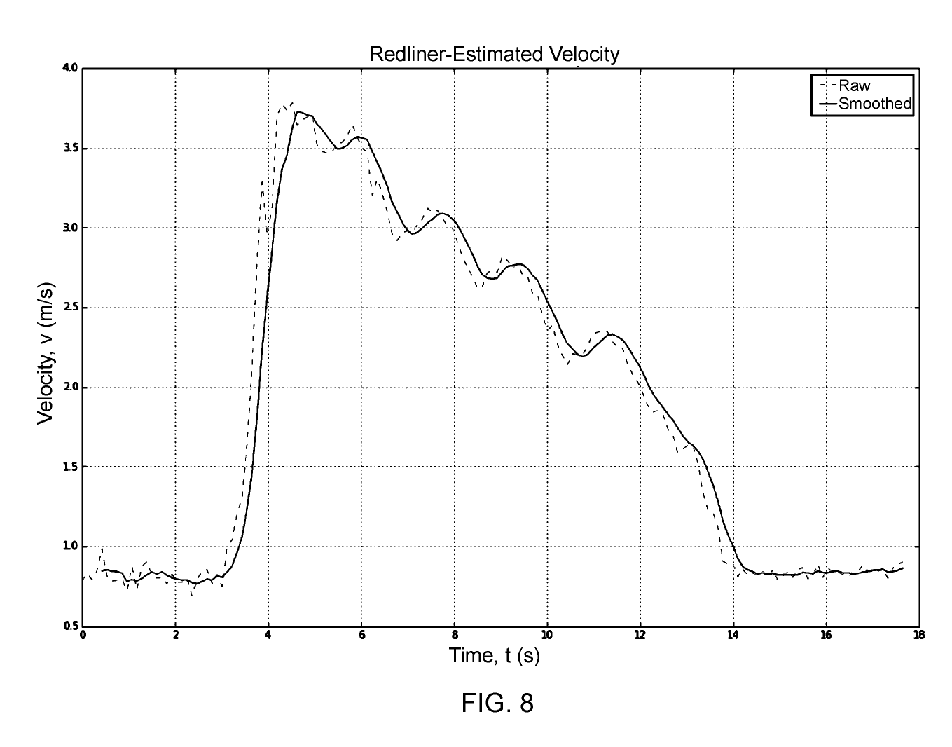

Implementations of system 100 have demonstrated in benchmarking tests that the detection of redline events corresponds closely with those obtained using the Smart^{WHEEL} clinical instrument for both activity monitoring and as a means to detect the frequency and circumstances of over exertion events during wheelchair propulsion. FIG. 8 is a graph illustrating the velocity of the wheelchair during a maximum standing start acceleration (a good indicator of “capacity”). The wheelchair was allowed to coast to a halt. The small oscillations after the primary push are attributed to wheelchair caster wheel shimmy. At the very end of the test, the user applied the hands to the wheel to slow to a complete halt.

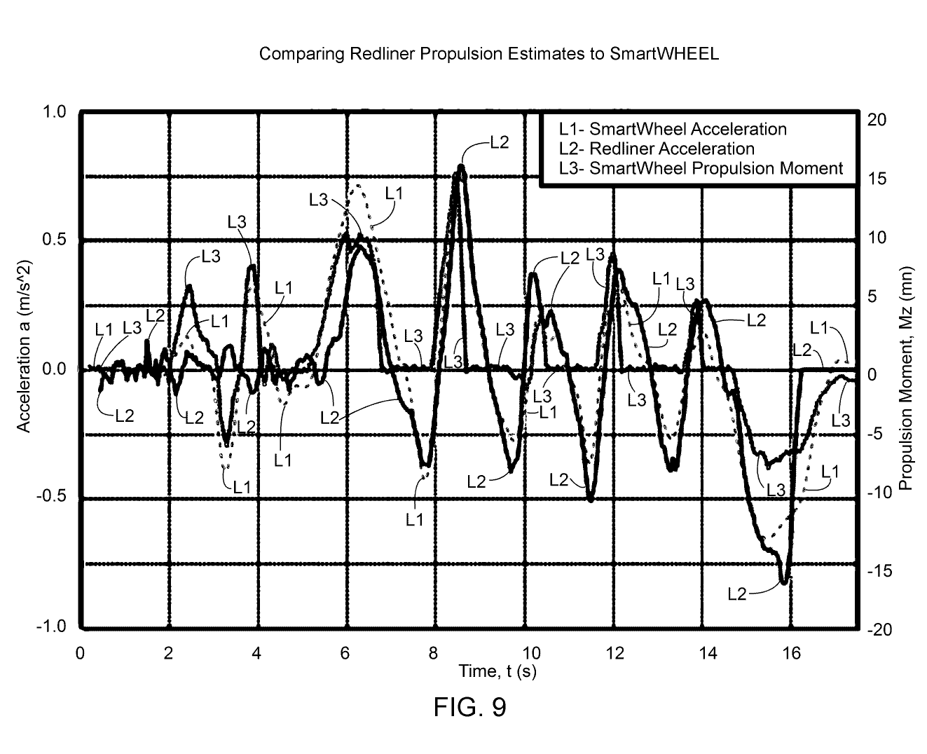

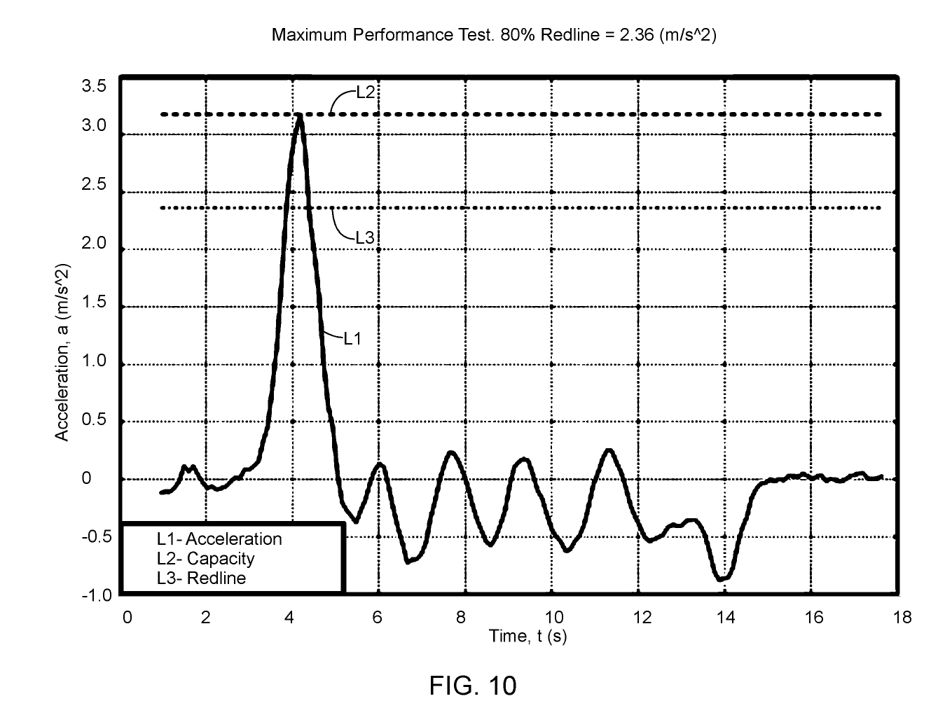

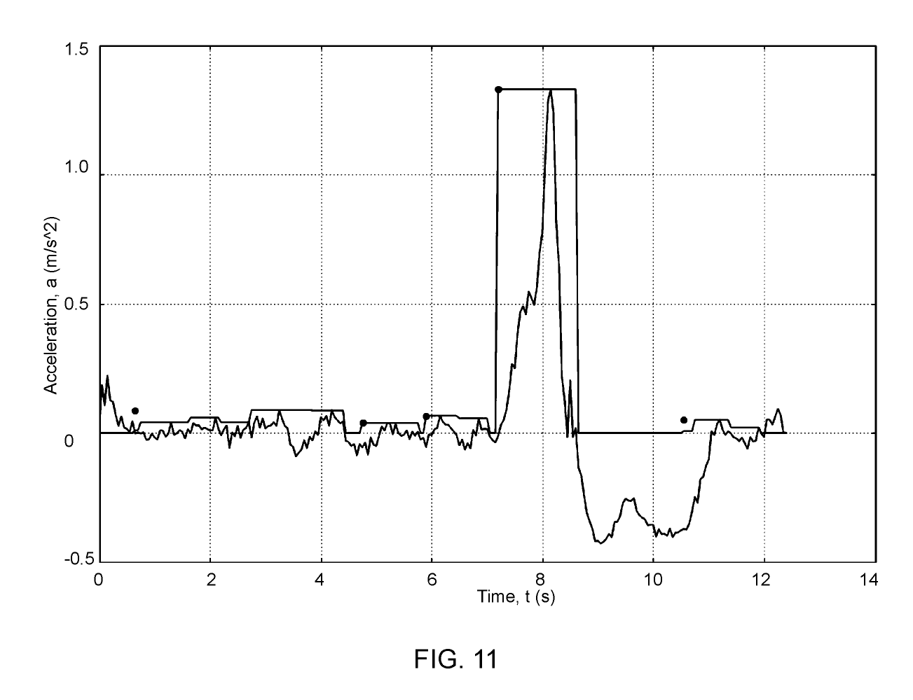

FIG. 9 is an example of a comparison of an example implementation the system described herein to Smart^{WHEEL}. FIG. 10 is a graph illustrating the results of example tests on example systems implemented according to one or more techniques of this disclosure. In the example illustrated in FIG. 10, a redliner signal has been processed to provide an indication of the acceleration of the wheelchair which in turn can be associated with the 80% redline, a strong propulsion push, and subsequent coasting pushes is illustrated. FIG. 10 is a graph illustrating the results of example tests on example systems implemented according to one or more techniques of this disclosure. In FIG. 10, an example of an algorithm applied to a series of small pushes followed by a large push to enable push events to be detected reliably is illustrated. FIG. 11 is a graph illustrating the results of example tests on example systems implemented according to one or more techniques of this disclosure. This illustrates how the algorithm applied to the acceleration signal can be used to identify individual pushes, including a large propulsion push associated with a sharp turn that is part of a sequence during typical wheelchair activities.

It should be noted that although the systems described herein are described with respect to wheelchairs, there are other applications where the sensor, communications, and analysis techniques described herein can be used to measure propulsion power. For example, elite cyclists use power meters to manage their performance in real time. The sensors currently in use are not only expensive but also require special components to be built into the bicycle's gearing and/or pedals. The example systems described herein can provide an inexpensive alternative that can be readily attached to a bicycle by all levels of cyclist interested in monitoring their power output.

Various examples have been described. These and other examples are within the scope of the following claims.

### APPENDIX A

Calibration of Redliner Sensor System 200

The following calibration was performed by rotating the wheel through increments of 90 degrees as the data was captured from the redliner sensor system 200. In order to get an indication of the response from the z-axis the wheel was removed and placed on its side. In the case of the x and y axes the difference in output for the maximum and minimum readings represents 2 g or 2*9.8 m/s/s. In the case of the z-axis the difference between the neutral reading and the reading lying on size=1 g.

The x-axis is aligned radially relative to the wheel and the y-axis tangentially.

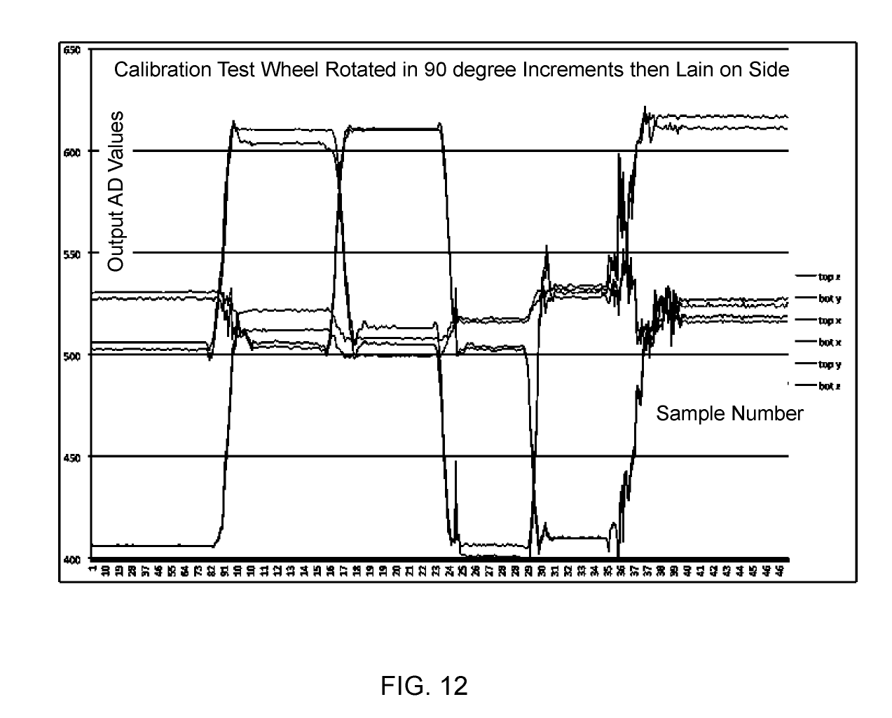

FIG. 12 shows a graph of the Calibration Test Wheel Rotated in 90 degree Increments then Lain on Side

Using this data, the following calibration constants were determined:

| Rel to g | top z | bot z | top x | bot x | top y | bot y |
|---|---|---|---|---|---|---|
| Neutral | 528 | 531 | 504.5 | 519.5 | 510 | 504 |
| pos g | NA | NA | 408 | 408 | 406 | 403 |
| neg g | NA | NA | 611 | 610 | 610 | 604 |
| On Side | 612 | 617 | NA | NA | NA | NA |
| Cal Const. | 8.57 | 8.78 | 10.36 | 10.31 | 10.41 | 10.26 |
| Offset | 528 | 531 | 504.5 | 503.5 | 510 | 504 |

The nominal sampling rate of the Redliner sensor system 200 is 10 Hz per dataset (6 samples) or a throughput of 10*6*16 bits per second=960 baud, well within the 9600 baud rate setup for the Xbee wireless units.

Taking the original calibration dataset and applying these calibration constants the following graph is obtained which should show, and does, that x- and y-axis data are 90 degrees out of phase, and that the values change from 0 to +9.8 to 0 to −9.8 m/s/s.

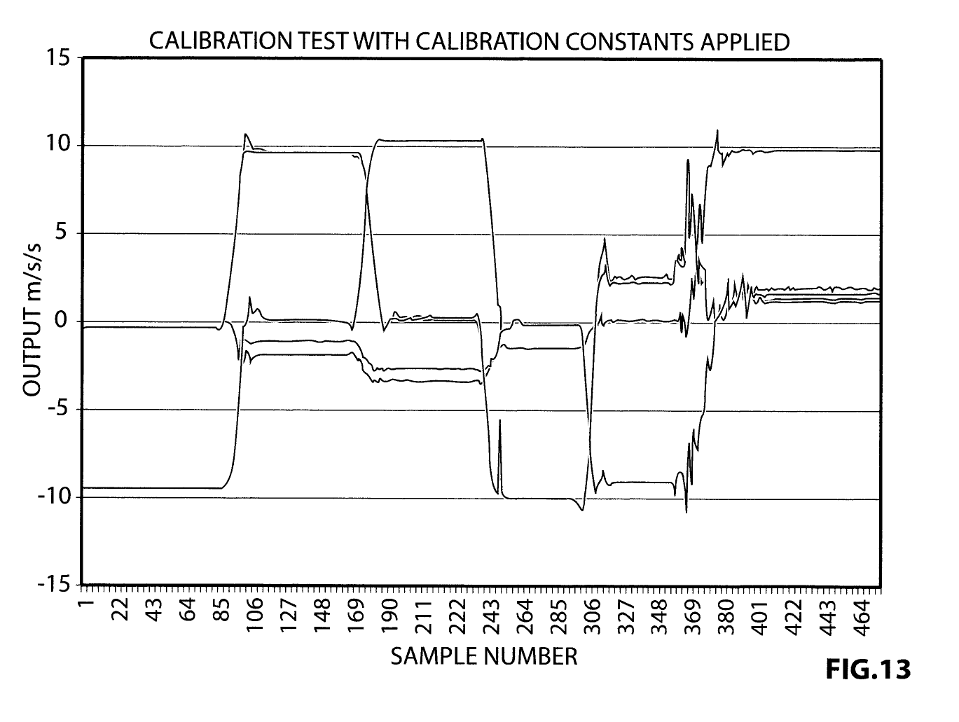

FIG. 13 shows a graph of output values during a calibration test with calibration constants applied.

Simple Analysis of Data

Order of Data Elements

Note there is a difference in the labeling of the variables between the labels provided by the Redliner sensor system 200 and the order in which the values are read out.

For the data generated in the trials the following is the order that the variables were stored:

| | | | | | |
|---|---|---|---|---|---|
| top y | bot y | top x | bot x | top z | bot z |

Note also there is an anomaly in the way data is stored for the 3^{rd} set of readings. For reasons not yet determined the last three columns in the dataset are displaced. The solution is to cut the three readings that overshoot the columns and past them on top of the last three columns corresponding to bot x, top z and bot x.

Method of Data Analysis

Referring to the technical note by Kionix¹ that angular velocity is determined by measuring the difference in the radial direction between two accelerometers separated by distance D. The angular acceleration is determined by calculating the difference in the tangential direction between the same two accelerometers. In the first prototype Redliner sensor system 200 the x-direction of the accelerometer measured the radial acceleration and the y-direction the tangential acceleration. ¹ Technical Note: AN 019 Using two tri-axis accelerometers for rotational measurements. 10th January 2008. http://www.kionix.com/sites/default/files/AN019%20Two%20accelerometers%2Ofor%20rotation.pdf

Note in the algorithm it is important to determine the absolute difference between the x-axis accelerometers. However, this is not the case for the two y-axis accelerometers. Remember in the x-axis case as the wheel rotates the accelerometers experience a change from −g to +g and yet it is the difference between the two accelerometers independent of gravity this is the indicator of the centripetal force, hence the need to obtain the absolute value.

Given the different surfaces that are experienced, there are small fluctuations in the resulting values for wheel velocity that are very likely differences in the response of the two accelerometers to impacts transmitted through the mechanical systems of the wheel and the Redliner 200 circuit board. These differences are smoothed out for the x-axis by a 20-sample moving window average. A 5-sample moving window average is used for the y-axis data. This averaging is applied to the resulting difference between the accelerometers, rather than the raw data. Applying averaging to the raw data should be examined more closely as an alternative approach in other embodiments.

Sample Results

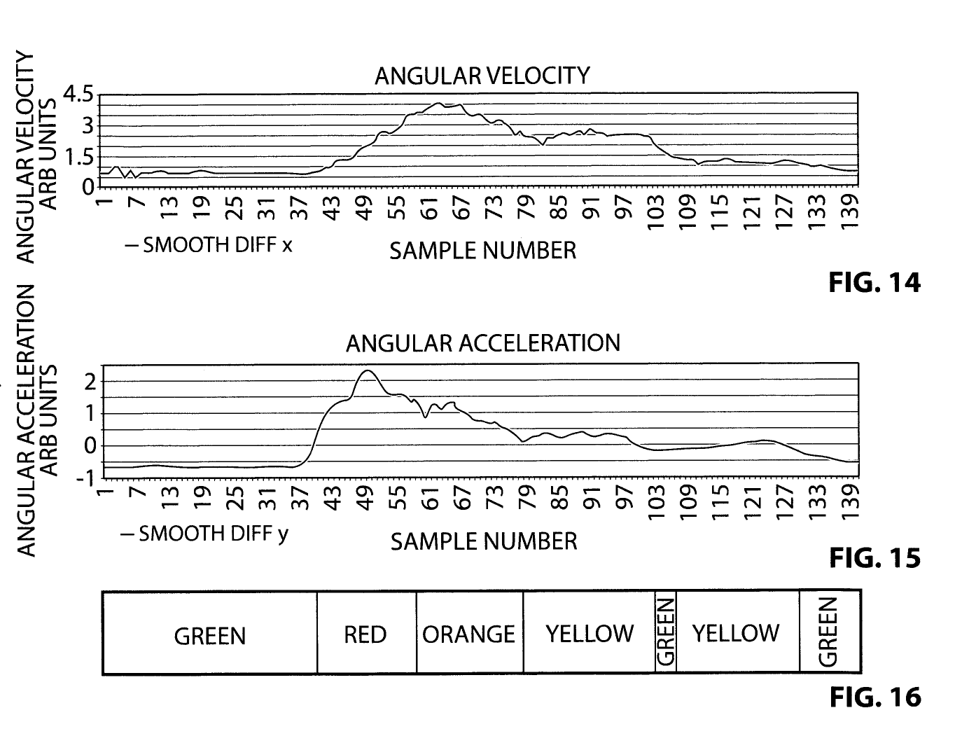

FIG. 14-16 illustrate charts for a single maximum push on a cobbled surface, a very challenging test for the system. FIG. 14 illustrates the Angular velocity, FIG. 15 illustrates the Angular AccelerationAcceleration, and FIG. 16 illustrates the colour coded exertion results.

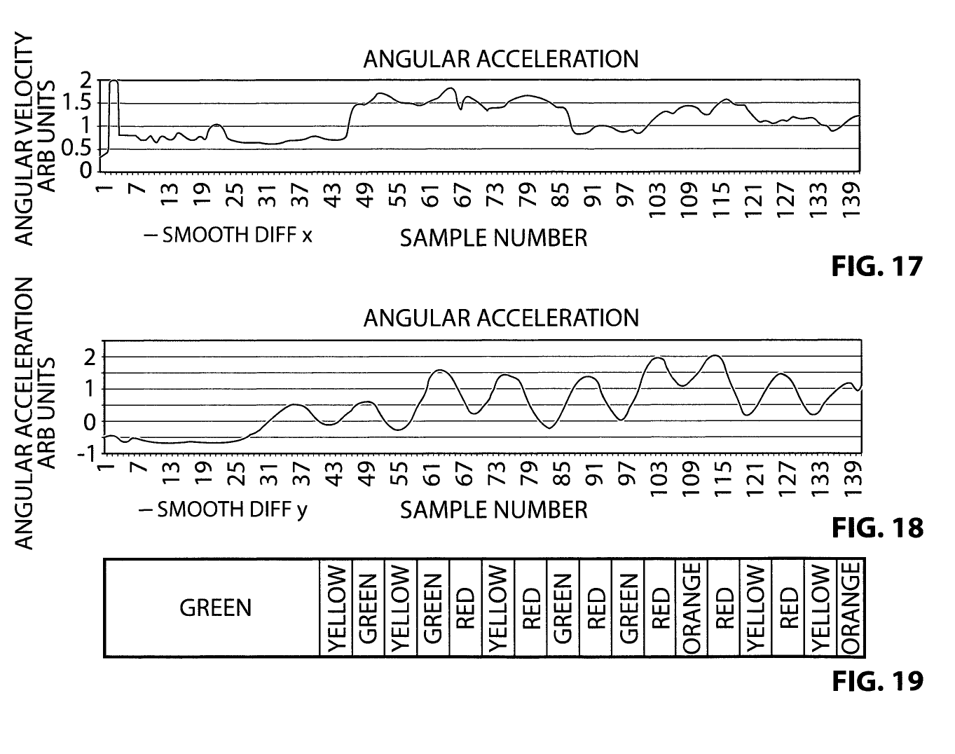

FIG. 17-19 illustrate charts for pushing on lino for multiple sub-maximal pushes. FIG. 17 illustrates the Angular velocity, FIG. 18 illustrates the Angular AccelerationAcceleration, and FIG. 19 illustrates the colour coded exertion results.

In the examples given, we have not encoded the activity spectrum to represent >80% of maximal capacity. This may be developed as part of the dashboard that accompanies the Redliner system 100. In the first instance, this could be developed in Matlab.

Although the invention has been described in connection with preferred embodiments, it should be understood that various modifications, additions, and alterations may be made to the invention by one skilled in the art. For instance, although a wireless Bluetooth transceiver 210 is utilized to communication sensor data from the sensor system 200 to the remote computing device 300, other types of communication protocols may be employed. Additionally, although it is beneficial for a transceiver 210 to be utilized thereby allowing two-way communication, in other embodiments, one-way broadcast communication of sensor data 200 may be transmitted from the sensor system 200 to one or more remote computing devices 300. Likewise, although the various components illustrated in FIG. 3 are described as being within the remote computing device 300, any of the illustrated and described components may instead or also be included within the sensor system 200 itself. For example, the sensor system may include the redliner application 316 stored within memory 212 thereby allowing the one or more processors within the local computing device 206 located on board the sensor system 200 to calculate the various wheel-motion values, compare with redliner threshold(s), issue alerts, and transmit sensor data to remote cloud storage via the Internet for later review by the user.

In other example modifications, a Kalman filter may be utilized instead of a moving-window-average filter to filter the data. Although some of the parameters in the above examples are hard-coded, such as the minimum activity level threshold, these parameters may all be made adjustable and can be set on a user-by-user basis. For instance, each user may store customized thresholds and other parameters in the storage device on either their sensor system 200, remote computing device 300, and/or cloud account. A measurement of the noise of the accelerometers 202, 204 may also be utilized to nullify any measurements that are received in the noisy realm. For example, if the accelerometers 202, 204 have an average differential noise of Δa_{N}, then readings are truncated using Δa=H(Δa−Δa_{N})Δa to avoid spurious data.

The various application programs may be implemented by software executed by one or more processors operating pursuant to instructions stored on a tangible computer-readable medium such as a storage device to perform the above-described functions of any or all aspects of the access controller. Examples of the tangible computer-readable medium include optical media (e.g., CD-ROM, DVD discs), magnetic media (e.g., hard drives, diskettes), and other electronically readable media such as flash storage devices and memory devices (e.g., RAM, ROM). The computer-readable medium may be local to the computer executing the instructions, or may be remote to this computer such as when coupled to the computer via a computer network such as the Internet. The processors may be included in a general-purpose or specific-purpose computer that becomes Redliner sensor system 200 or any of the above-described units as a result of executing the instructions.

In other embodiments, rather than being software modules executed by one or more processors, the modules may be implemented as hardware modules configured to perform the above-described functions. Examples of hardware modules include combinations of logic gates, integrated circuits, field programmable gate arrays, and application specific integrated circuits, and other analog and digital circuit designs. Functions of single modules and devices may be separated into multiple units, or the functions of multiple modules and devices may be combined into a single unit.

Unless otherwise specified, features described may be implemented in hardware or software according to different design requirements. In addition to a dedicated physical computing device, the word “server” may also mean a service daemon on a single computer, virtual computer, or shared physical computer or computers, for example. All combinations and permutations of the above-described features and embodiments may be utilized in conjunction with the invention.

What is claimed is:

1. A system for monitoring activity level of a wheeled vehicle while being manually propelled by a user, the system comprising:
at least one sensor;
a wireless transmitter coupled to the at least one sensor; and
a base supporting the at least one sensor and the wireless transmitter;
wherein the base is mountable to a wheel of the wheeled vehicle; and
the wireless transmitter is operable to wirelessly transmit a plurality of data corresponding to sensor information received from the at least one sensor regarding motion of the wheel over time.

2. The system of claim 1, wherein the wireless transmitter is operable to transmit the data substantially in real time as new sensor information is received from the at least one sensor.

3. The system of claim 1, wherein the at least one sensor includes an accelerometer.

4. The system of claim 1, wherein:
the at least one sensor includes a plurality of accelerometers; and
at least two of the plurality of accelerometers are positioned on the base such that, when mounted on the wheel, a first accelerometer is located closer to a center of the wheel than a second accelerometer.

5. The system of claim 1, wherein the at least one sensor includes an inclinometer.

6. The system of claim 1, wherein the at least one sensor includes a global positioning system receiver.

7. The system of claim 1, wherein the base includes one or more backing plates with guides for mounting the base to spokes of the wheel.

8. The system of claim 1, further comprising:
a remote computing device having a wireless receiver operable to receive the data transmitted by the wireless transmitter;
wherein the remote computing device includes one or more processors operable to dynamically determine a wheel-motion value according to the data, and issue an alert to the user when the wheel-motion value is within a predetermined percentage of a predetermined maximum motion value.

9. The system of claim 8, wherein the predetermined percentage is set at eighty-percent of the predetermined maximal motion value.

10. The system of any one of claims 8 to 9, wherein the wheel-motion value represents wheel velocity.

11. The system of any one of claims 8 to 9, wherein the wheel-motion value represents wheel acceleration.

12. The system of any one of claims 8 to 9, wherein the wheel-motion value represents wheel pushes.

13. The system of any one of claims 8 to 9, wherein:
the wheel-motion value corresponds to motion of the wheel at a current time; and
the alert is issued by the one or more processors substantially in real time in response to the wheel-motion value exceeding the predetermined percentage of the predetermined maximum motion value.

14. A method of monitoring activity level of a wheeled vehicle while being manually propelled by a user, the method comprising:
supporting at least one sensor and a wireless transmitter on a base;
mounting the base to a wheel of the wheeled vehicle; and
wirelessly transmitting a plurality of data corresponding to sensor information received by the wireless transmitter from the at least one sensor regarding motion of the wheel over time.

15. The method of claim 14, further comprising transmitting the data substantially in real time as new sensor information is received from the at least one sensor.

16. The method of claim 14, wherein the at least one sensor includes an accelerometer.

17. The method of claim 14, wherein:
the at least one sensor includes a plurality of accelerometers; and
the method further comprises positioning at least two of the plurality of accelerometers on the base such that, when mounted on the wheel, a first accelerometer is located closer to a center of the wheel than a second accelerometer.

18. The method of claim 14, wherein the at least one sensor includes an inclinometer.

19. The method of claim 14, wherein the at least one sensor includes a global positioning system receiver.

20. The method of claim 14, further comprising mounting the base to spokes of the wheel utilizing one or more backing plates with guides.

21. The method of claim 14, further comprising:
receiving the data transmitted by the wireless transmitter by a remote computing device having a wireless receiver;
dynamically determining a wheel-motion value according to the data by the remote computing device; and
issuing an alert to the user by the remote computing device when the wheel-motion value is within a predetermined percentage of a predetermined maximum motion value.

22. The method of claim 21, wherein the predetermined percentage is set at eighty-percent of the predetermined maximal motion value.

23. The method of any one of claims 21 to 22, wherein the wheel-motion value represents wheel velocity.

24. The method of any one of claims 21 to 22, wherein the wheel-motion value represents wheel acceleration.

25. The method of any one of claims 21 to 22, wherein the wheel-motion value represents wheel pushes.

26. The method of any one of claims 21 to 22, wherein:
the wheel-motion value corresponds to motion of the wheel at a current time; and
the method further comprises issuing the alert by the remote computing device substantially in real time in response to the wheel-motion value exceeding the predetermined percentage of the predetermined maximum motion value.
